(19) United States
(12) Patent Application Publication
(10) Pub. No.: US 2016/0349431 A1
(43) Pub. Date: Dec. 1, 2016

(54) BACKLIGHT MODULE AND LIQUID CRYSTAL DISPLAY DEVICE

(71) Applicant: HON HAI PRECISION INDUSTRY CO., LTD., New Taipei (TW)

(72) Inventors: LI-CHIAO HUANG, New Taipei (TW); KUAN-WEI CHOU, New Taipei (TW); JOU-HSUAN WU, New Taipei (TW)

(21) Appl. No.: 15/163,793

(22) Filed: May 25, 2016

Related U.S. Application Data
(60) Provisional application No. 62/167,911, filed on May 29, 2015.

(51) Int. Cl. F21V 8/00

(52) U.S. Cl. CPC G02B 6/005; G02B 6/0055; G02B 6/0068; G02B 6/0053; G02B 6/0056

(57) ABSTRACT

A backlight module comprises a light guide plate, at least one light source configured to emit a mixed light of a first primary color and a second primary color, a phosphor film capable of generating light having a third primary color, and a reflector. The light guide plate guides the mixed light to the phosphor film. A part of the mixed light excites the phosphor film to generate light having the third primary color. The light having the third primary color mixes with other parts of the mixed light to create white light. The reflector reflects light leaking from the light guide plate back to the light guide plate. A display device using the backlight module is also provided.

### CROSS-REFERENCE TO RELATED APPLICATIONS

This application is a nonprovisional patent application of and claims the benefit of U.S. Provisional Patent Application No. 62/167,911, filed May 29, 2015 and titled “BACKLIGHT MODULE AND LIQUID CRYSTAL DISPLAY DEVICE,” the disclosure of which is hereby incorporated herein by reference in its entirety.

### FIELD

The subject matter herein generally relates to a backlight module and a liquid crystal display device using the backlight module.

### BACKGROUND

A liquid crystal display (LCD) does not emit light and hence requires a backlight for its function as a visual display. Recently, Light Emitting Diodes (LEDs) have been employed as light sources for backlighting LCDs. However, the LED's luminous efficiency may be not so good, the backlight module and the display device exist the problem that the transmittance of light are not high enough, thereby reducing the display effect.

### BRIEF DESCRIPTION OF THE FIGURES

Implementations of the present technology will now be described, by way of example only, with reference to the attached figures.

FIG. 1 is an exploded, isometric view of a first embodiment of a display device of the present disclosure.

FIG. 2 is an assembled isometric view of a first embodiment of a display device of the present disclosure.

FIG. 3 is a cross-sectional view of the display device of FIG. 2 along line III-III.

FIG. 4 is a cross-sectional view of a second embodiment of a display device of the present disclosure.

FIG. 5 is a cross-sectional view of a third embodiment of a display device of the present disclosure.

FIG. 6 is a cross-sectional view of a fourth embodiment of a display device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

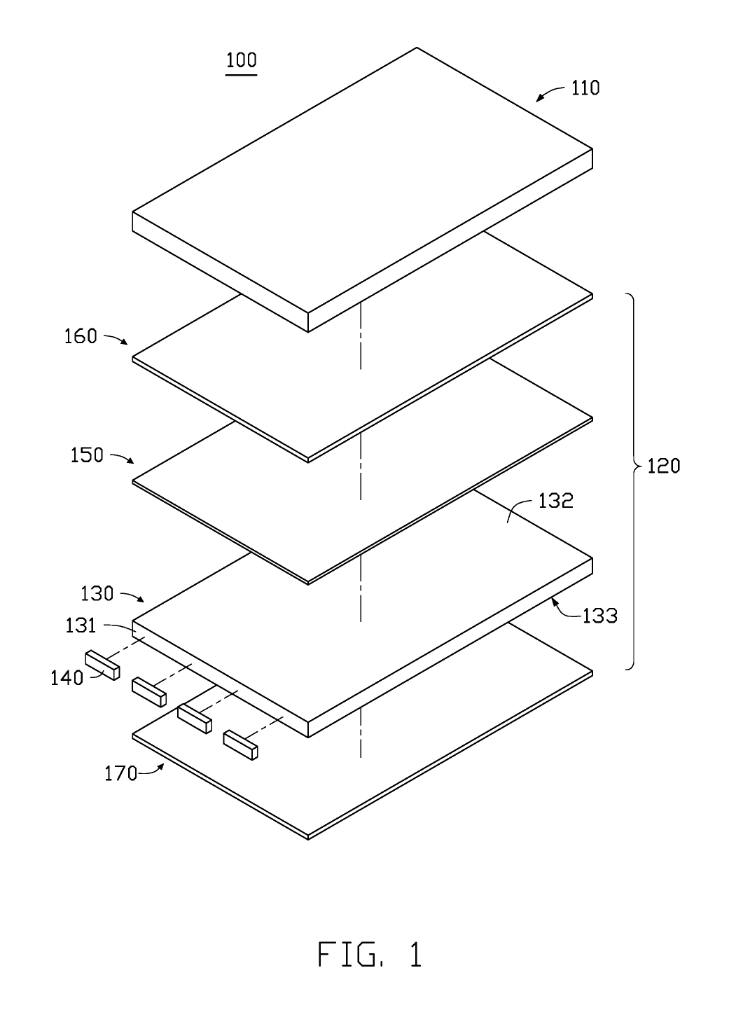

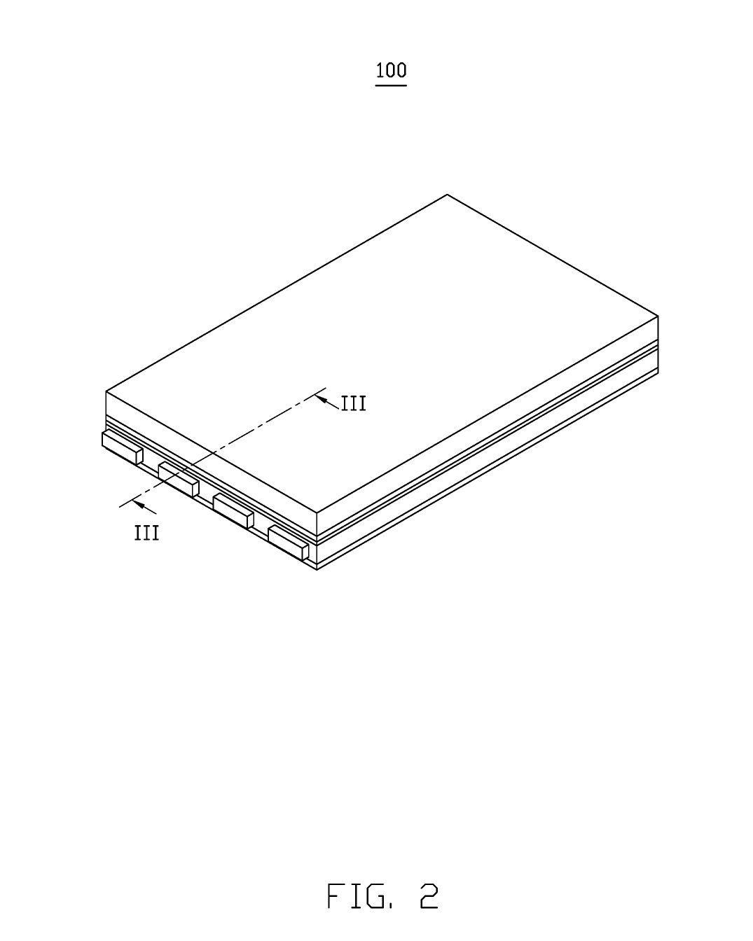

FIG. 1 illustrates an exploded isometric view of a first embodiment of a display device 100 of the present disclosure. FIG. 2 illustrates an assembled isometric view of a first embodiment of a display device 100 of the present disclosure. The display device 100 includes a display panel 110, and a backlight module 120 disposed under the display panel 110. The backlight module 120 provides white plane light required by the display panel 110. The display panel 110 may be a liquid crystal display panel. The backlight module 120 includes a light guide plate 130, at least one light source 140, a phosphor film 150, an optical film 160, and a reflector 170.

The light guide plate 130 has a light incident surface 131, a light emitting surface 132 connected to the light incident surface 131, and a bottom surface 133 opposite to the light emitting surface 132 and connected to the light incident surface 131. The at least one light source 140 is disposed beside and faces the light incident surface 131. The phosphor film 150 and the reflector 170 are located at opposite sides of the light guide plate 130. The phosphor 150 faces the light emitting surface 132. The reflector 170 faces the bottom surface 133. The optical film 160 is disposed at a side of the phosphor film 150 away from the light guide plate 130 and sandwiched between the phosphor film 150 and the display panel 110.

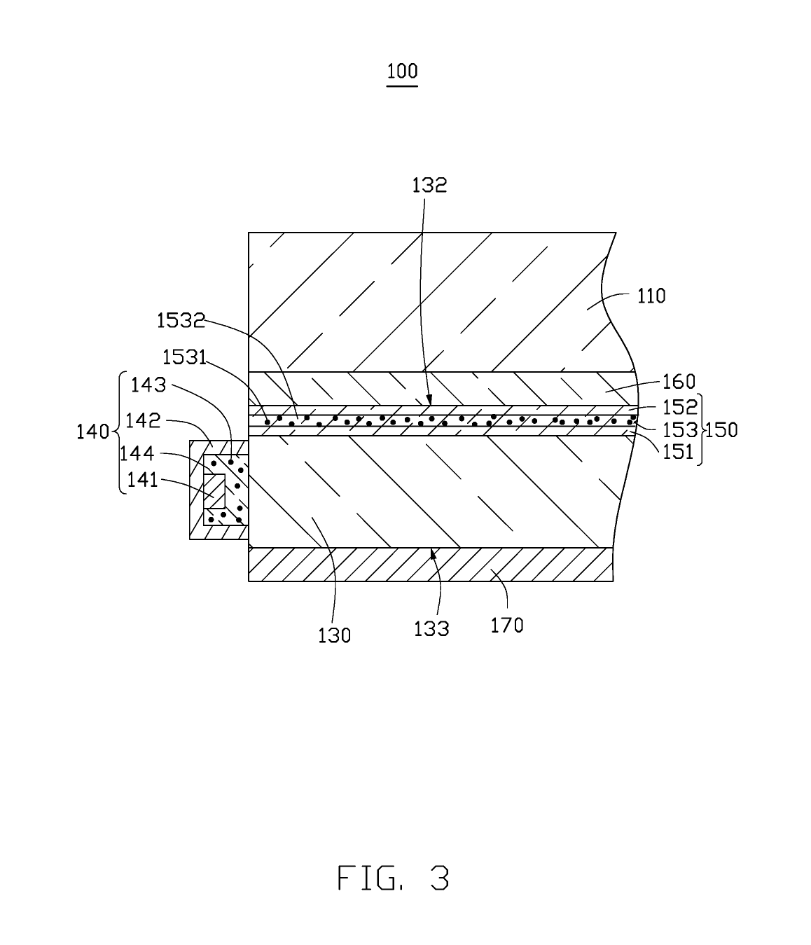

FIG. 3 illustrates a cross-sectional view of the display device 100 of the present disclosure. In at least one embodiment, the ate least one light source 140 may be a light emitting diode comprising a package body 142, an emitting element 141 fixed in the package body 142, and a first phosphor 143 distributed in the package body 142 and covering the emitting element 141. It can be understood, the first phosphor 143 can be mixed within a base material 144 to form a seal compound covering the emitting element 141. The base material 144 is transparent material, such as transparent resin. The emitting element 141 is configured to provide light with a first primary color. In this embodiment, the emitting element 141 is a blue light emitting diode chip, and the first primary color is blue. The first phosphor 143 and the emitting element 141 are integrally formed. The first phosphor 143 may be coated directly on the emitting element 141 or may be disposed in the package body 142, such that the light from the emitting element 141 emits outwardly through the first phosphor 143. In this embodiment, the first phosphor 143 has a second primary color, and the second primary color is red. In other words, the first phosphor 143 may be red phosphor. The red phosphor material may include Mn⁴⁺ or Eu²⁺, such as K₂SiF₆: Mn⁴⁺, Ca₂Si₅N₈: Eu²⁺, Sr₂Si₅N₈: Eu²⁺, Ca₂AlSiN₃: Eu²⁺, CaS: Eu²⁺, Mg₂TiO₄: Mn⁴⁺, or K₂TiF₆: Mn⁴⁺ etc.

Parts of the light having the first primary color from the emitting element 141 excite the first phosphor 143 to generate light having the second primary color. The light having the second primary color mixes with the other parts of the light having the first primary color from the emitting element 141 such that the at least one light source 140 emits a mixed light of the first primary color and the second primary color. In this embodiment, the emitting element 141 is a blue light emitting diode chip, the first phosphor 143 is red phosphor, and the at least one light source 140 emits a mixed light of blue light and red light.

The mixed light of the first primary color and the second primary color emitting from the at least one light source 140 passes through the light incident surface 131 into the light guide plate 130 and leaves the light guide plate 130 through the light emitting surface 132, outwardly emitting. The mixed light emitting from the light emitting surface 132 of the light guide plate 130 is provided to the phosphor film 150. The reflector 170 reflects light leaking from the bottom of the light guide plate 130 back to the light guide plate 130.

The phosphor film 150 may include a bottom barrier layer 151, a top barrier layer 152, and a phosphor layer 153 located between the bottom barrier layer 151 and the top barrier layer 152. The bottom barrier layer 151 and the top barrier layer 152 are configured to protect the phosphor layer 153. The phosphor layer 153 has a base material 1531 and a second phosphor 1532 dispersed in the base material 1531. The base material 1531 can be transparent material, such as transparent resin, and the second phosphor 1532 has a third primary color and is configured to provide light of a third primary color.

In this embodiment, the third primary color is green. In other words, the phosphor layer 153 is a green phosphor layer and has green phosphor. The material of the green phosphor may include SrGa₂S₄: Eu²⁺, and a proportion of the phosphor 1532 in the phosphor layer 153 may be range from 5% to 20% by weight. Moreover, a thickness of the phosphor layer 153 may be range from 5 um to 50 um, and a thickness of each of the bottom barrier layer 151 and the top barrier layer 152 may be range from 5 um to 50 um. Accordingly, a thickness of the phosphor film 150 may be range from 15 um to 150 um.

The optical film 160 may be a diffuser or a brightness enhancement film. In other embodiments, the optical film 160 may not be required, and then white plane light from the phosphor film 150 may directly emit toward the display panel 110. In this embodiment, the optical film 160 is a dual-brightness enhancement film (D-BEF) or a brightness enhancement film-reflective polarizer (BEF-RP). A part of the mixed light from the light guide plate 130 excites the phosphor film 150 to generate light having the third primary color. The light having the third primary color mixes with the mixed light from the light guide plate 130 to generate white light, and the white light is provided to the display panel 110 via the optical film 160. The other parts of the mixed light from the light guide plate 130 is reflected to the light guide plate 130 by the optical film 160, reflected by reflector 170, and provided to the phosphor film 150 once again. Accordingly, the other parts of the mixed light can be changed to white light by the phosphor film 150, and the white light is provided to the display panel 110 via the optical film 160. The first primary color, the second primary color, and the third primary color are different, and each is a monochrome color.

The backlight module 120 generates white light by the light of the emitting element 141 exciting the first phosphor 143 and the phosphor film 150.

Because the first light conversion in the at least one light source 140 and the second light conversion in the phosphor film 150 are substantially separated from each other, the light conversion efficiency of the two conversions are improved. Furthermore, because the optical film 160 can reflect the other parts of the mixed light from the light guide plate 130 to the light guide plate 130 by the optical film 160, the light guide plate 130 and the reflector 170 provide the other parts of the mixed light to the optical film 160 second time, the light conversion efficiency of the backlight module 120 and the liquid crystal panel are also improved. Accordingly, luminous efficiency and brightness the backlight module 120 and the liquid crystal panel are also improved.

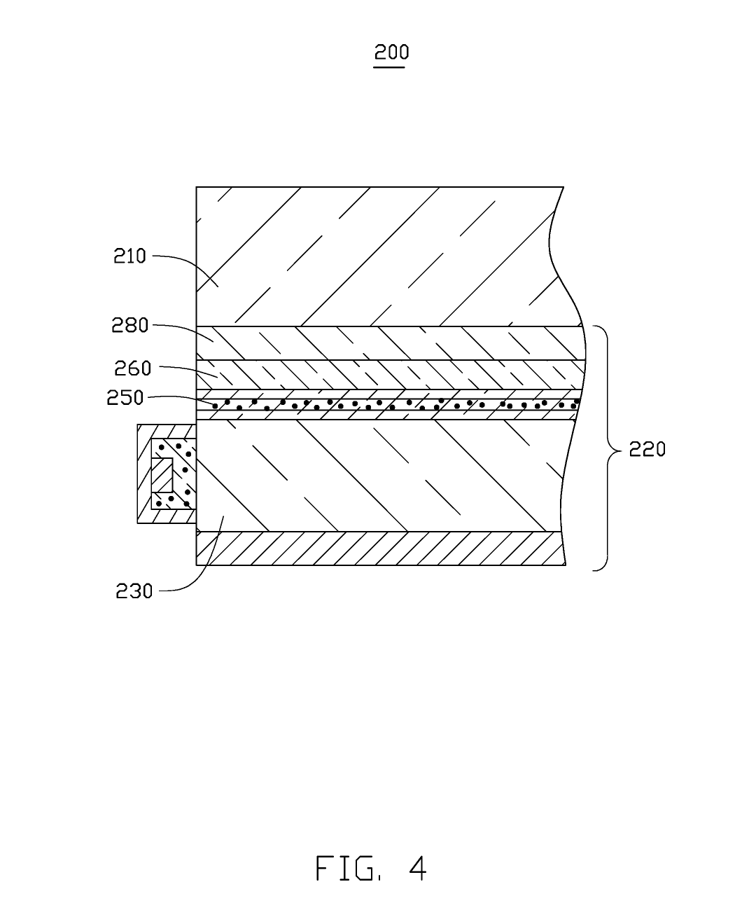

FIG. 4 illustrates a cross-sectional view of a second embodiment of a display device 200 of the present disclosure. The display device 200 includes a display panel 210, and a backlight module 220 disposed under the display panel 210. The display device 200 is similar to the display device 100 of the first embodiment. Unlike the first embodiment, the display device 200 comprises two optical films 260 and 280. The optical film 260 and the optical film 280 are disposed on the phosphor film 250 away from the light guide plate 230 and sandwiched between the display panel 210 and the phosphor film 250. Each of the optical film 260 and the optical film 280 may be a diffuser or a brightness enhancement film. In this embodiment, the optical film 280 is a dual-brightness enhancement film (D-BEF) or a brightness enhancement film-reflective polarizer (BEF-RP), and the optical film 260 may be a diffuser or a brightness enhancement film. Except the above difference, the remaining contents of the second embodiment of a display device 200 are same with the first embodiment of a display device 100.

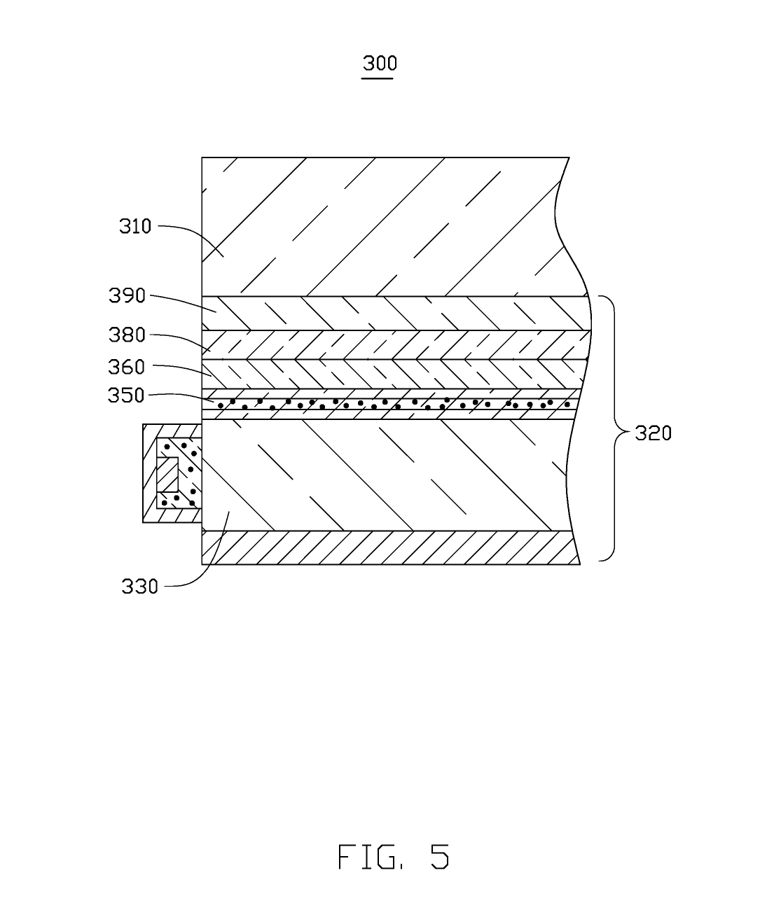

FIG. 5 illustrates a cross-sectional view of a third embodiment of a display device 300 of the present disclosure. The display device 300 includes a display panel 310, and a backlight module 320 disposed under the display panel 310. The display device 300 is similar to the display device 100 of the first embodiment. Unlike the first embodiment, the display device 300 comprises three optical films 360, 380 and 390. The optical film 360, the optical film 380 and the optical film 390 are disposed on the phosphor film 350 away from the light guide plate 330 and sandwiched between the display panel 310 and the phosphor film 350. Each of the optical film 360, the optical film 380 and the optical film 390 may be a diffuser or a brightness enhancement film. In this embodiment, the optical film 390 is a dual-brightness enhancement film (D-BEF) or a brightness enhancement film-reflective polarizer (BEF-RP), and the optical films 360 and 380 may be a diffuser or a brightness enhancement film. Except the above difference, the remaining contents of the third embodiment of a display device 300 are same with the first embodiment of a display device 100.

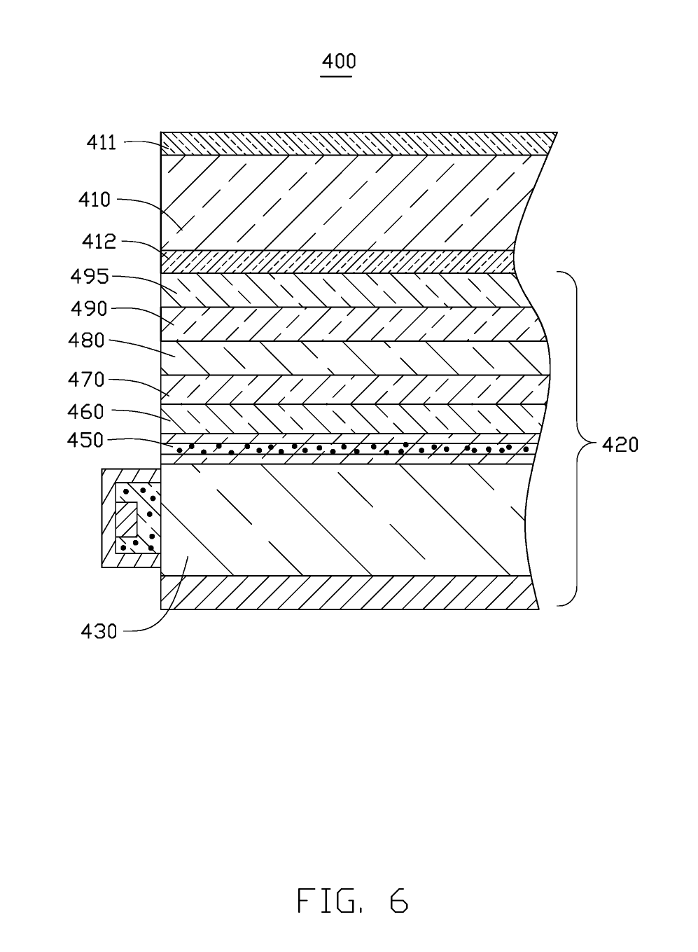

FIG. 6 illustrates a cross-sectional view of a fourth embodiment of a display device 400 of the present disclosure. The display device 400 includes a display panel 410, and a backlight module 420 disposed under the display panel 410. The display device 400 is similar to the display device 100 of the first embodiment. Unlike the first embodiment, the display device 400 comprises five optical films 460, 470, 480, 490, and 495. The optical films 460, 470, 480, 490, and 495 are disposed on the phosphor film 450 away from the light guide plate 430 and sandwiched between the display panel 410 and the phosphor film 450. In this embodiment, the optical film 495 is an advanced polarizer film (APF) which can be attached a lower surface of a display panel, and each of the optical films 460, 470, 480, and 490 may be a diffuser or a brightness enhancement film. In detail, the display device 400 further comprises a top polarizer 411 and a lower polarizer 412 which are disposed at opposite sides of the display panel 410. The optical film 495 is attached a lower surface of the lower polarizer 412. Alternatively, the optical film 495 can also be the lower polarizer 412 which includes the function of the advanced polarizer film. A brightness enhancement structure of the advanced polarizer film can be integrated into the lower polarizer 412 to obtain corresponding functions. Except the above difference, the remaining contents of the fourth embodiment of a display device 400 are same with the first embodiment of a display device 100.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A backlight module comprising:
a light guide plate;
at least one light source configured to emit a mixed light of a first primary color and a second primary color;
a phosphor film capable of generating light having a third primary color; and
a reflector;
wherein the light guide plate guides the mixed light to the phosphor film, a part of the mixed light excites the phosphor film to generate light having the third primary color, the light having the third primary color mixes with other parts of the mixed light to create white light, and the reflector reflects light leaking from the light guide plate back to the light guide plate.

2. The backlight module of claim 1, wherein each of the at least one light source comprises an emitting element configured to provide light with a first primary color and a first phosphor covering the emitting element; the first phosphor has a second primary color; the light with the first primary color is capable of exciting the first phosphor to generate light having a second primary color; and the light having the second primary color mixes with the light having the first primary color to create the mixed light.

3. The backlight module of claim 2, wherein the phosphor film comprises a second phosphor, the mixed light excites the second phosphor to generate the light having the third primary color.

4. The backlight module of claim 3, wherein the first primary color is red, the second primary color is blue, and the third primary color is green.

5. The backlight module of claim 1, wherein the light guide plate has a light incident surface, a light emitting surface connected to the light incident surface, and a bottom surface opposite to the light emitting surface and connected to the light incident surface; the at least one light source is disposed beside and faces the light incident surface; the phosphor film and the reflector are located at opposite sides of the light guide plate; the phosphor faces the light emitting surface; and the reflector faces the bottom surface.

6. The backlight module of claim 5, further comprising at least one optical film disposed at a side of the phosphor film away from the light guide plate; the at least one optical film is a diffuser or a brightness enhancement film and is capable of reflecting parts of the mixed light from the light guide plate to the light guide plate once again; and the light guide plate guiding the parts of the mixed light to the phosphor film to generate white light.

7. The backlight module of claim 6, wherein when a number of the at least one optical film is one, the optical film is dual-brightness enhancement film or a brightness enhancement film-reflective polarizer.

8. The backlight module of claim 6, wherein when a number of the at least one optical film is two, one of the optical films is a dual-brightness enhancement film or a brightness enhancement film-reflective polarizer, and the other one is a diffuser or a brightness enhancement film.

9. The backlight module of claim 6, wherein when a number of the at least one optical film is three, one of the optical films is a dual-brightness enhancement film or a brightness enhancement film-reflective polarizer, and each of the other two optical films is a diffuser or a brightness enhancement film.

10. The backlight module of claim 6, wherein when a number of the at least one optical film is five, one of the optical film is an advanced polarizer film, and each of the other four optical films is diffuser or a brightness enhancement film.

11. A display device, comprising:
display panel; and
a backlight module disposed under the display panel, the backlight module providing white light required by the display panel;
wherein the backlight module comprising:
a light guide plate;
at least one light source configured to emit a mixed light of a first primary color and a second primary color;
a phosphor film capable of generating light having a third primary color; and
a reflector;
wherein the light guide plate guides the mixed light to the phosphor film, a part of the mixed light excites the phosphor film to generate light having the third primary color, the light having the third primary color mixes with other parts of the mixed light to create white light to provide to the display panel, and the reflector reflects light leaking from the light guide plate back to the light guide plate.

12. The display device of claim 11, wherein each of the at least one light source comprises an emitting element configured to provide light with a first primary color and a first phosphor covering the emitting element; the first phosphor has a second primary color; the light with the first primary color is capable of exciting the first phosphor to generate light having a second primary color; the light having the second primary color mixes with the light having the first primary color to create the mixed light.

13. The display device of claim 12, wherein the phosphor film comprises a second phosphor, and the mixed light excites the second phosphor to generate the light having the third primary color.

14. The display device of claim 13, wherein the first primary color is red, the second primary color is blue, and the third primary color is green.

15. The display device of claim 11, wherein the light guide plate has a light incident surface, a light emitting surface connected to the light incident surface, and a bottom surface opposite to the light emitting surface and connected to the light incident surface; the at least one light source faces the light incident surface; the phosphor film and the reflector are located at opposite sides of the light guide plate; the phosphor faces the light emitting surface; and the reflector faces the bottom surface.

16. The display device of claim 15, further comprising at least one optical film disposed at a side of the phosphor film away from the light guide plate and sandwiched between the phosphor film and the display panel; the at least one optical film is a diffuser or a brightness enhancement film and is capable of reflecting parts of the mixed light from the light guide plate to the light guide plate once again; the light guide plate guiding the parts of the mixed light to the phosphor film to generate white light; and the white light is provided to display panel by the least one optical film.

17. The display device of claim 16, wherein when a number of the at least one optical film is one, the optical film is dual-brightness enhancement film or a brightness enhancement film-reflective polarizer.

18. The display device of claim 16, wherein when a number of the at least one optical film is two, one of the optical films is a dual-brightness enhancement film or a brightness enhancement film-reflective polarizer, and the other one is a diffuser or a brightness enhancement film.

19. The display device of claim 16, wherein when a number of the at least one optical film is three, one of the optical films is a dual-brightness enhancement film or a brightness enhancement film-reflective polarizer, and each of the other two optical films is a diffuser or a brightness enhancement film.

20. The display device of claim 16, wherein when a number of the at least one optical film is five, one of the optical film is an advanced polarizer film, and each of the other four optical films is diffuser or a brightness enhancement film.

21. The display device of claim 20, further comprising a top polarizer and a lower polarizer which are disposed at opposite sides of the display panel; the optical film being an advanced polarizer film is attached a lower surface of the lower polarizer.

22. The display device of claim 11, wherein the display panel is a liquid crystal display panel.
